(19) United States
(12) Patent Application Publication
(10) Pub. No.: US 2007/0043553 A1
(43) Pub. Date: Feb. 22, 2007

(54) Machine translation models incorporating filtered training data

(75) Inventor: William B. Dolan, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/204,672

(22) Filed: Aug. 16, 2005

(51) Int. Cl. G06F 17/28

(52) U.S. Cl. 704/2

(57) ABSTRACT

Filtering techniques are applied to extract, based on apparent fluency in a target language, relatively accurate training data based on the output of one or more translation engines. The extracted training data is utilized as a basis for training a statistical machine translation system.

### BACKGROUND

As a result of the growing international community created by technologies such as the Internet, machine translation is beginning to achieve widespread use and acceptance. While direct human translation may still prove, in many cases, to be a more accurate alternative, translations that rely on human resources are generally less time and cost efficient than translations derived from automated systems. Under these conditions, human involvement is often relied upon only when translation accuracy is of critical importance.

The quality of automated machine translations has generally not increased at the same rate as the rising demand for such functionality. It is generally recognized that, in order to obtain high quality automatic translations, a machine translation system must be significantly customized. Customization often times includes the addition of specialized vocabulary and rules to translate texts in a desired domain. Trained computational linguists are often relied upon to implement this type of customization. A customized translation system will often be effective within a targeted domain but will be far from colloquial. Thus, a specialized system will often produce a less than completely accurate translation of, for example, text extracted from personal emails.

One general approach to machine translation has been to equip an automated system to apply a large number of customized, often hand-coded, translation rules. Some translation systems of this type have been coded up with direct human assistance over a period of decades. Often times the translation rules applied within these types of systems are relatively rigid. Regardless, the accuracy of translations produced by hand-coded and similar systems has proven to be quite limited, especially for translation within a general domain.

Another general approach to machine translation has been to equip an automated system to apply broadly focused statistical models that have been trained, often automatically, on sets of human-translated parallel bilingual texts. This type of system is capable of producing relatively accurate translations at least in instances where translation is to occur within a limited domain for which models have been specifically trained. For example, accuracy may be reasonable when translation is limited to being within a highly technical domain where parallel bilingual data is readily available. For example, some companies will pay professional translators to translate large collections of their data into another language where there is some pressing motivation to do so.

Thus, one way to support consistently accurate machine translations within a general domain is to train statistical translation models based on an adequately large collection of accurate translation data. Generally speaking, accuracy in a broad domain will be dependent upon the quantity and broadness of quality data upon which models can be trained. Unfortunately, there is a relative shortage of trustworthy translation data upon which statistical models can be trained in a broad domain. In some cases, a publisher may consider it worthwhile to pay for a professional translation. Generally speaking however, accurate data of this type is difficult to find in mass quantity. To employ humans to produce the amount of data needed to accurately translate within a broad domain would generally require an unreasonable investment of human capital.

It is worth noting that a recent trend in machine translation involves training statistical translation models based on identified mappings between languages in comparable, as opposed to aligned or parallel, data sets. An example of comparable data might be two collections of text, in different languages, known to be about the same subject matter, such as the same news event. Mappings can be drawn from the comparable texts, even when there is no initial knowledge about how the texts might line up with one another. Techniques for building effective translation models based on comparable data are, at this point, still relatively crude and limited in terms of effectiveness. At least until such techniques are drastically improved, there will still be a need in machine translation for large amounts of accurate parallel bilingual pairings of text.

The discussion above is merely provided for general background information and is not intended for use as an aid in determining the scope of the claimed subject matter. Also, it should be noted that the claimed subject matter is not limited to implementations that solve any noted disadvantage.

### SUMMARY

This Summary is provided to introduce, in a simplified form, a selection of concepts that are further described below in the Detailed Description. This Summary is not intended to identify key features or essential features of the claimed subject matter, nor is it intended for use as an aid in determining the scope of the claimed subject matter.

Filtering techniques are applied to extract, based on apparent fluency in a target language, relatively accurate training data based on the output of one or more translation engines. The extracted training data is utilized as a basis for training a statistical machine translation system.

### BRIEF DESCRIPTION OF THE DRAWINGS

FIG. 1 is a block diagram of one computing environment in which some embodiments may be practiced.

FIG. 2 is a schematic diagram generally illustrating a system for training a statistical translation engine.

FIG. 3 is a flow chart diagram illustrating steps associated with generation of a statistical translation model.

### DETAILED DESCRIPTION

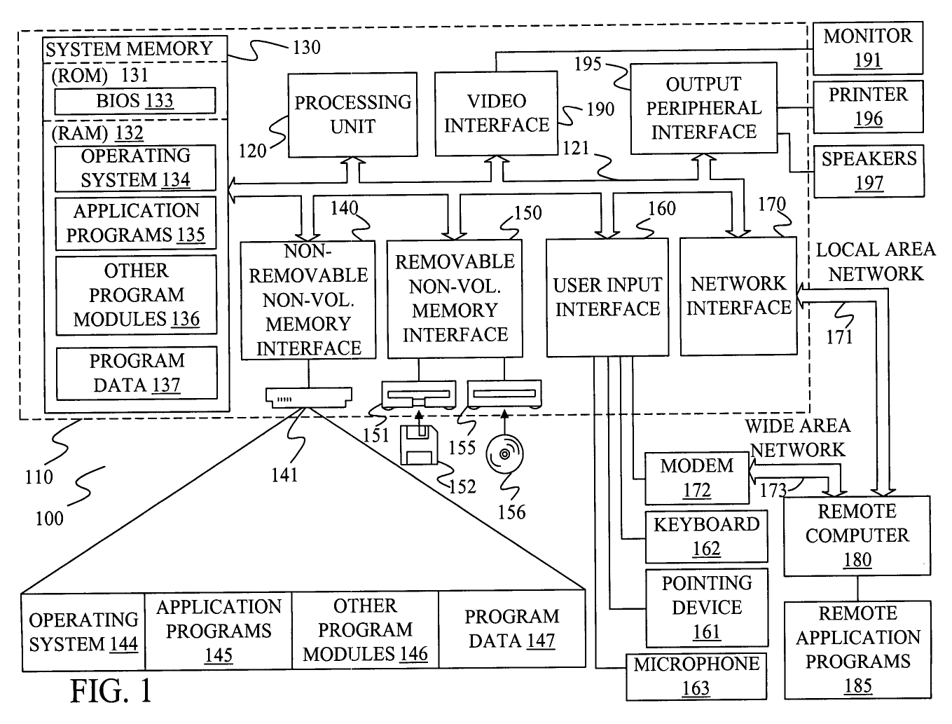

FIG. 1 illustrates an example of a suitable computing system environment 100 in which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Within the field of machine translation, one way to support consistently accurate translations within a general domain is to train statistical translation engines based on an adequately large collection of accurate bilingual translation data. Generally speaking, translation accuracy in a broad domain is dependent upon the quantity, accuracy and broadness of the training data. Unfortunately, there is a relative shortage of trustworthy translation data upon which statistical models can be trained in a broad domain.

There currently exists a variety of generally non-statistical translation systems and services known to have the capacity to produce bilingual translation data. For example, a wide range of different shrink-wrapped and web-based translation products are currently available to the general public. Many of these systems and services are configured to apply a large number of customized, often hand-coded, translation rules. Some of these systems and services have been coded up with direct human assistance over a period of decades. An example of this type of product is the popular Babelfish application provided by Systran Software Inc. of San Diego, Calif. Other examples include systems and services provided by WorldLingo Translations of Las Vegas, Nev., as well as products provided by Toshiba.

The described generally non-statistical translation systems and services are configured to accurately translate many individual broad-domain sentences and phrases. Overall, however, the translation quality is relatively low, particularly when translating in a broad domain such as a corpus of email. Thus, training a statistical machine translation system based on the output of these types of systems and services will at best yield a translation system that produces equally poor output—and one that does so more slowly.

To the extent that output from a generally non-statistical translation engine is accurate, it would be desirable to use the corresponding bilingual translation data as a basis for training a generally unrelated statistical machine translation system. In one embodiment, filtering techniques are applied to the output of the non-statistical system in order restrict training data to that which appears to be high quality in terms of accuracy. Thus, the non-statistical system can be utilized to translate large amounts of monolingual text. Then, the results are filtered aggressively to retain only translations that appear to be high quality in terms of accuracy. The object is to produce a clean set of training data that will support the training of a statistical machine translation engine that is configured to produce more accurate translations than the system that produced the training data.

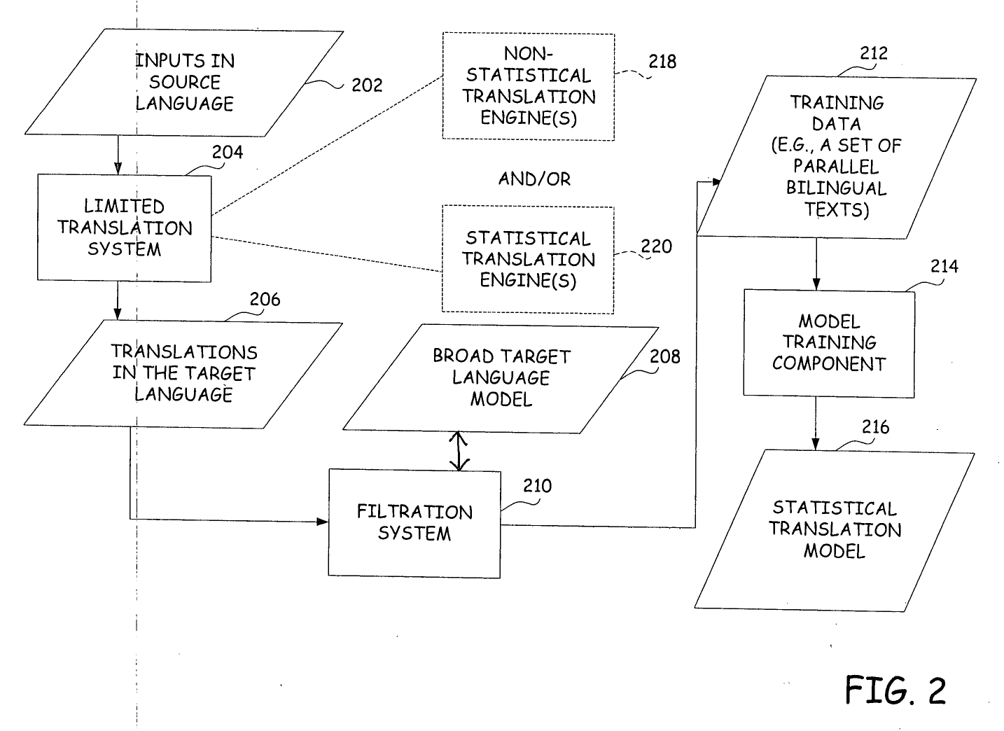

FIG. 2 is a schematic diagram generally illustrating a system for training a statistical translation engine for improved fluency in a target language. A plurality of inputs 202, which are in a source language, are provided to a translation system 204. System 204 processes inputs 202 in order to produce translations 206, which are in a target language.

As is indicated by block 218, translation system 204 may be a generally non-statistical translation engine 218, as has been described. In another embodiment, however, system 204 may be a statistical translation engine 220, such as a statistical system configured to translate within a limited domain (e.g., the domain of a specific company, profession, etc.). In addition, translation system 204 could just as easily include multiple engines each configured to translate the same inputs 202, and each configured to contribute output to the collection of translations 206. In general, system 204 may include none, one or more generally non-statistical engines, as well as none, one or more statistical engines.

Translations 206, which are in the target language, are provided to a filtration system 210. In one embodiment, the purpose of system 210 is to automatically filter translations 206 to produce a smaller data set that is higher quality in terms of accuracy.

In accordance with one embodiment, the filter that is applied by system 210 is a trigram language model, which is indicated in FIG. 2 as item number 208. Filtering system 210 is illustratively configured to apply language model 208 to produce a probability that a given translation string 206 is fluent in the target language. Language model 208 is illustratively trained on equivalent (but not parallel) data taken from the target language. For example, in one embodiment, language model 208 is trained on an arbitrarily large corpus of news data in the target language.

Those skilled in the art will appreciate that other filtering techniques are also within the scope of the present invention. There are many known methods for training a language model to evaluate fluency in the context of a large corpus of monolingual data. All such methods should be considered within the scope of the present invention.

Translations 206 that demonstrate a desirable or configurable level of fluency in the target language are included in a set of training data 212. In one embodiment, each translation included within training data 212 is paired with its corresponding source language input. Thus, training data 212 may be embodied as a set of parallel bilingual texts. Training data 212 is provided to a model training component, which utilizes the data as a basis for generating a statistical translation model 216.

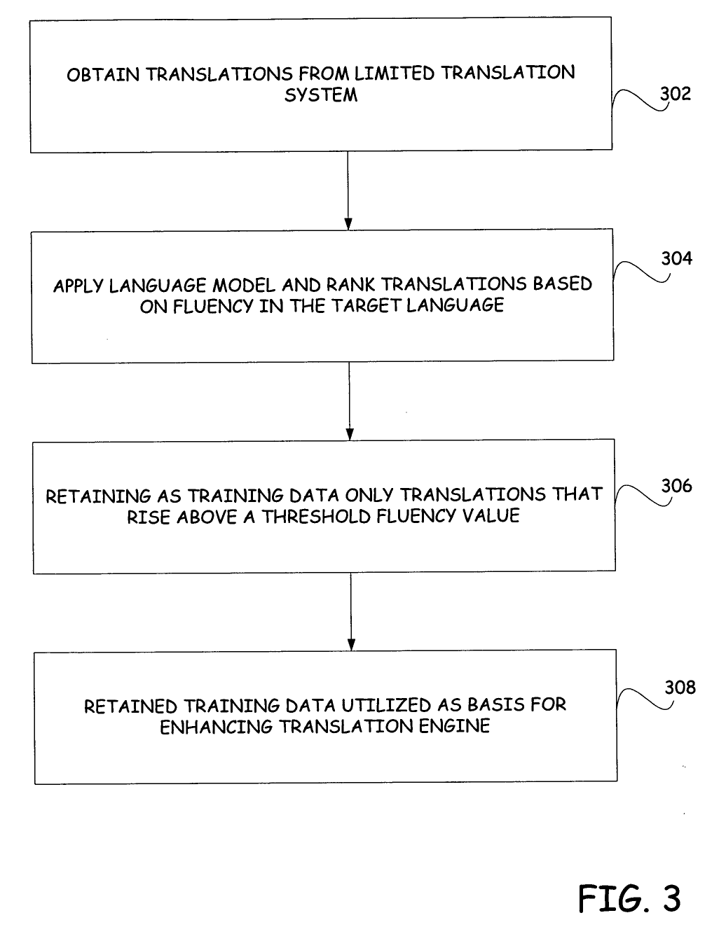

FIG. 3 is a flow chart diagram illustrating steps associated with generation of a statistical translation model. In accordance with block 302, translations are obtained from a limited translation system. In accordance with block 304, a language model is applied, and the translations are ranked based on fluency in the target language. In accordance with block 306, only translations that rise above a desirable or configurable fluency threshold are retained as training data. Finally, the retained training data is utilized as a basis for enhancing a statistical translation engine (step 308).

The level of fluency that a translation must demonstrate to be included in the training data is illustratively configurable. For example, in one embodiment a threshold value is applied on a percentage basis (e.g., the top 5% most fluent translations are retained). To avoid having a detrimental impact on the quality of the statistical translation engine, the filter can be applied relatively aggressively. For example, if necessary to ensure quality, 10, 100 or even more translations may be obtained from system 204 for every translation included in training data 212.

It is worth reiterating that it is within the scope of the present invention that output from multiple machine translation engines can be combined to provide a broad collection of translations 206. For example, a given news article in the source language may be translated into the target language by multiple translation engines, such as 5 different commercial translation systems. In one embodiment, the combined output is then subjected to filtering by filtration system 210. In one embodiment, training data 212 includes, in addition to bilingual texts that correspond to adequately fluent translations, hand or human translated bilingual texts. Collectively, all of the bilingual texts are utilized as a training set to support training of an enhanced statistical translation engine.

It is also worth reiterating that the limited translation system 204 utilized to produce the translation pool can include a statistical and/or non-statistical translation engine. The statistical translation model 216 that is ultimately trained is illustratively different than any model associated with a component of system 204. In one embodiment, a statistical translation engine associated with system 204 essentially provides application of a local measure of fluency in that it selects the most fluent translation from a lattice of possible translations for a given input string. Application of filtration system 210 then essentially leads to a global measure of fluency across the whole of a related corpus. Thus, the overall system enforces a global notion of translation quality. Thus, a given translation of a source text, even thought it is indicated by a statistical translation engine as being locally fluent, may be globally rejected in favor a different translation of the same source text. In this manner, poor mappings associated with bad local translations may be filtered out.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of training a translation model, the method comprising:
receiving from a first translation system a set of translations from a source language to a target language;
selecting from said set a limited number of translations that demonstrate a desirable level of fluency in the target language; and
utilizing bilingual data that corresponds to the limited number of translations as a basis for training the translation model.

2. The method of claim 1, wherein utilizing bilingual data as a basis for training the translation model further comprises utilizing bilingual data as a basis for training a translation model associated with a statistical translation engine.

3. The method of claim 1, wherein receiving a set of translations further comprises receiving a set of translations that includes translations derived from a plurality of translation engines.

4. The method of claim 3, wherein receiving a set of translations further comprises receiving a set of translations that includes at least one translation derived from a statistical translation engine, as well as at least one translation derived from a non-statistical translation engine.

5. The method of claim 1, wherein receiving a set of translations further comprises receiving a set of translations that includes two different translations of a single input, the two different translations being derived from different translation engines.

6. The method of claim 1, wherein receiving a set of translations further comprises receiving a set of translations that includes at least one translation derived from a non-statistical translation engine.

7. The method of claim 1, wherein receiving a set of translations further comprises receiving a set of translations that includes at least one translation derived from a statistical translation engine.

8. The method of claim 1, wherein receiving a set of translations further comprises receiving a set of translations that includes at least one translation derived by a human source.

9. The method of claim 1, wherein selecting from said set comprises evaluating fluency of translations in said set based on a language model trained on a broad collection of data taken from the target language.

10. The method of claim 9, wherein evaluating fluency based on a language model comprises evaluating fluency based on a trigram language model.

11. The method of claim 1, wherein selecting from said set comprises selecting a limited number of translations that rise above an adjustable fluency threshold.

12. The method of claim 1, wherein utilizing bilingual data comprises utilizing a translation included in said limited number, along with its corresponding data in the source language.

13. A system for generating a collection of training data for training a translation model, comprising:
a source translation system configured to, for a plurality of inputs in a source language, generate a plurality of corresponding translations in a target language;
a language model configured to be utilized as a basis for evaluating fluency of the plurality of corresponding translations in the target language; and
a filtration system configured to apply the language model and include in the collection of training data only those corresponding translations that rise above a desirable level of fluency.

14. The system of claim 13, wherein the source translation system is configured to utilize at least two different translation engines to generate the plurality of corresponding translations.

15. The system of claim 13, wherein the language model is trained on a broad collection of data taken from the target language.

16. The system of claim 13, wherein the language model is a trigram language model.

17. A collection of training data configured to be utilized as a basis for training a translation model, the collection comprising a set of parallel, bilingual sentence pairs, wherein each sentence pair includes a sentence in a target language having a desired level of fluency as measured against a language model trained on a broad collection of data in the target language.

18. The collection of claim 17, wherein the language model is a trigram language model.

19. The collection of claim 17, wherein at least one of the parallel, bilingual sentence pairs includes an input to a statistical machine translation engine, as well as a corresponding output.

20. The collection of claim 17, wherein at least one of the parallel, bilingual sentence pairs includes an input to a non-statistical machine translation engine, as well as a corresponding output.
